(19) United States
(12) Patent Application Publication
(10) Pub. No.: US 2015/0330022 A1
(43) Pub. Date: Nov. 19, 2015

(54) Controller And Method For Controlling A Property Of An Object

(71) Applicant: VALMET AUTOMATION OY, Espoo (FI)

(72) Inventors: Calvin FU, Ontario (CA); Jarmo OLLANKETO, Julkujauml;rvi (FI); Mira KIVIMÄKI, Pirkkala (FI)

(73) Assignee: VALMET AUTOMATION OY, Espoo (FI)

(21) Appl. No.: 14/654,028

(22) PCT Filed: Dec. 21, 2012
(86) PCT No.: PCT/FI2012/051291

§ 371 Date: Jun. 19, 2015

(51) Int. Cl. D21G 9/00; G05B 17/02

(52) U.S. Cl. CPC D21G 9/0009; G05B 17/02

(57) ABSTRACT

An apparatus in a manufacturing process of a sheet including: a measurement arrangement, a controller and an actuator arrangement regulating at least one property of the sheet; the measurement arrangement being configured to provide the controller with controlled variable data about at least one property of the sheet; the controller having available a predetermined model based on temporally or spatially dependent disturbance; and the controller being configured to form a manipulated variable for the actuator arrangement on the basis of the model in response to the disturbance.

### FIELD

The invention relates to a controller and method for controlling property of an object.

### BACKGROUND

The following description of background art may include insights, discoveries, understandings or disclosures, or associations together with disclosures not known to the relevant art prior to the present invention but provided by the invention. Some of such contributions of the invention may be specifically pointed out below, whereas other such contributions of the invention will be apparent from their context.

Process systems such as paper mills use a predictive control of a multiplicity of actuators. When the processes are initiated for the first time or after a stop such as a sheet break in a paper production, the process is controlled by a steady state control.

However, the steady state control cannot regulate the actuators properly or at all since the process is in a transient period. The delay in the proper control often continues for tens of minutes. To have the undesired transient period as short as possible, the process control typically makes aggressive control actions against process output variation on the basis of the steady state model which often lead to overacting. The aggressive control may cause the process state oscillate such that the process reaches rather quickly but momentarily a setpoint after which the process slides again away from the target range. Thus with or without the aggressive control, a result is a long off-specification state of the process under the steady state control during a transition period.

Hence, there is a need for a better process control.

### BRIEF DESCRIPTION

An object of the invention is to provide an improved solution for control.

According to an aspect of the present invention, there is provided an apparatus of claim 1.

According to another aspect of the present invention, there is provided an apparatus of claim 2.

According to another aspect of the present invention, there is provided an apparatus of claim 10.

According to another aspect of the present invention, there is provided a method of claim 14.

According to another aspect of the present invention, there is provided a method of claim 15.

Although the various aspects, embodiments and features of the invention are recited independently, it should be appreciated that all combinations of the various aspects, embodiments and features of the invention are possible and within the scope of the present invention as claimed.

The present solution provides advantages. The temporal and spatial changes which may be considered disturbance can be taken into account in the control and thus avoiding problems associated with the steady state control.

### LIST OF DRAWINGS

Embodiments of the present invention are described below, by way of example only, with reference to the accompanying drawings, in which

FIG. 1 illustrates an example of a measurement and control configuration of a sheet manufacturing process;

FIG. 2 illustrates an example of measuring and controlling the sheet;

FIG. 3A illustrates an example of behavior of a sheet variation quality trajectory;

FIG. 3B illustrates an example of an effect of a duration of a break on the predetermined model related to disturbance caused by the break;

FIG. 4 illustrates an example of measured caliper profile;

FIG. 5 illustrates an example of present error in caliper profile;

FIG. 6 illustrates an example of predicted error in caliper profile;

FIG. 7 illustrates an example of change in error profile;

FIG. 8 illustrates an example of predicted future caliper profile change;

FIG. 9 illustrates an example of control action profile;

FIG. 10 illustrates an example of a load test using a 1.5% higher load in the middle;

FIG. 11 illustrates an example of a load test using a decreased load the tending side;

FIG. 12 illustrates an example of a load test using an increased load at both sides of the calendar;

FIG. 13 illustrates an example of a flow chart of a method using a model of a disturbance; and

FIG. 14 illustrates an example of a flow chart of a method using a model of time dependent disturbance during a transient period.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

In this application steady state control may be considered such that a behavior of a process change from a given control action will continue to be within the same expected range from a model as it has done up to the present state. The steady state of a process is usually reached after a delay from an initiation of the process. The delay represents a transient period and the delay may also be called as a warm-up period or cooling down period. The duration of the transient time may be different in different processes. During the transient period one or more controlled variables cannot be controlled or cannot be properly controlled using control actions performed by the steady state control i.e. a process output doesn't follow a process input in a manner characteristic to the steady state control.

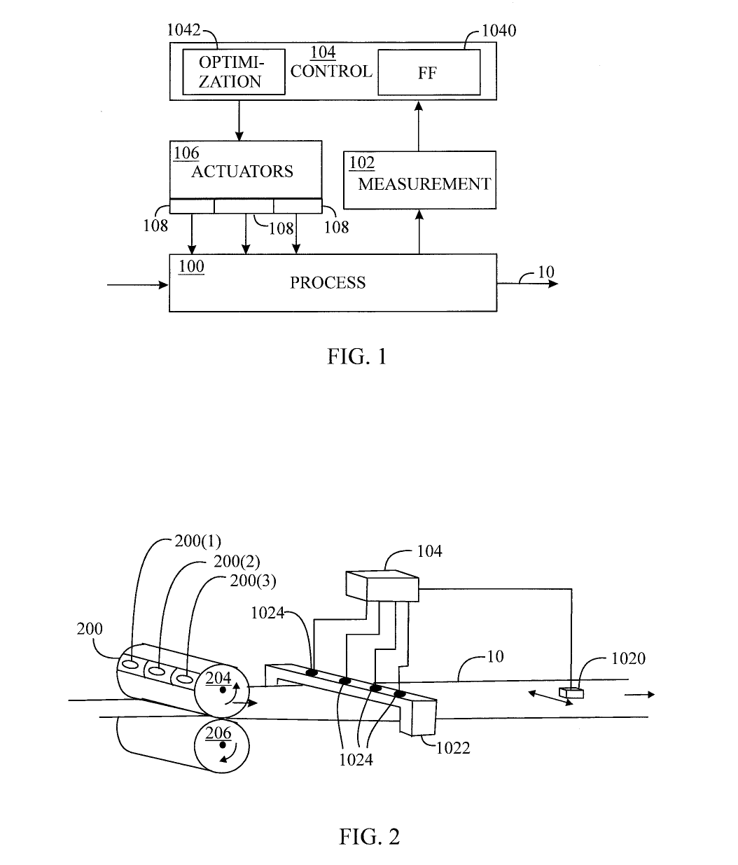

FIG. 1 shows an example of a measurement and control configuration of a sheet 10 manufacturing process. The sheet 10 may be paper, cardboard, metal, plastic or the like. In an embodiment, the process 100 may refer to a paper machine or to a section of it. A measurement arrangement 102 measures the process 100 and provides a predictive controller 104 with controlled variable data about at least one property of the sheet 10 in the process 100. The at least one property may be caliper, basis weight, moisture, ash content, color, coat weight (for coated paper), thickness of the sheet or the like. The caliper refers to thickness of paper or cardboard. The measurement of the property of a sheet may be direct or indirect such that the sensor of the measurement arrangement 102 outputs a value of the property, or the value of the property is computed on the basis of measurement values and potentially other information. The measurement may be performed using optical radiation, microwave radiation, mechanical instrument or the like and the measurement per se can be considered known to a person skilled in the art. The manner according to which the measurement as such is accomplished doesn't limit implementation of the control.

At least one actuator 108 of the actuator arrangement 106 regulates directly or indirectly the at least one property which is measured by the measurement arrangement 102. The actuator arrangement 106 regulates at least one property of the sheet. Here the measurement 102 refers to an array of measurement points across the direction of sheet width, with typically up to 2000 measurement points; the actuator 106 refers to an array of control action locations across the direction of sheet width, with typically up to 300 control action locations. There could be several of such measurements (for different sheet properties) and actuators in the control application. That is why the manipulated variable and the controlled variable may comprise one or more element in a vector or matrix form.

The predictive controller 104 has a predetermined model based on time dependent disturbance available during a transient period of the manufacturing process. The disturbance can be associated with the actuator arrangement. Thus, the disturbance may be considered to be at least partly caused by the actuator arrangement such that one or more of its properties is out of a steady state range. On the other hand, the disturbance may be considered as a process disturbance where the process refers to the environment of the actuator arrangement. Both concepts of the disturbance lead to the fact that the controlled variable drifts out from a desired range which is controllable by the steady state control. The controller 104 then forms a manipulated variable for the actuator arrangement 106 in response to the disturbance on the basis of the model. In other words, the controller 104 forms a command on the basis of the model of the disturbance and feeds the command to the actuator arrangement 106. Then the actuator arrangement 106 regulates the process on the basis of the command.

The predictive controller 104 may form data associated with future controlled variable on the basis of an estimate of a time dependent disturbance in a transient period. That is, the controller 104 has a feed forward controller part 1040 which may form data associated with at least one future controlled variable as a time dependent function of a change in the measured manipulated variable. The time dependent function estimates and compensates for the time dependent disturbance. The function may be understood as a model which the feed forward controller part 1040 has for performing the estimation of at least one actuator 108 of the actuator arrangement 106 and the model is used for forming of at least one manipulated variable. The function or model may be mathematically operable and it may have been made beforehand by a user.

Alternatively, the model may have been learned and/or it may continuously be learned by the feed forward controller part 1040 on the basis of the data it has and/or it receives and stores in a databank of its memory. A learning controller may be based on a neural network, for example. Data about values and/or changes of controlled values and or manipulated variable from a plurality transient periods of the same actuator arrangement in the same process may be used to make the function more accurate time after time.

The data the feed forward part 1040 may receive is the measured controlled variables at different moments. The data the feed forward controller 1040 has may also comprise general information about the actuator arrangement 106. In this way, the disturbance may be accounted for before the feedback control takes actions in response to it and before it has time to freely affect the process 100. Thus the function efficiently compensates for the time dependent disturbance during the transient period.

The time dependent disturbance may be related to an operational break of the actuator arrangement 106. That may take place in conjunction with a sheet break, for example. When the shutdown happens, the actuator arrangement 106 regulating the property of the sheet 10 is switched off and/or driven out of its normal regulating state. The process 100 may also be fully or partly shut down. The change in a state of the actuator arrangement 106 may be mechanical, thermal and/or electrical, for example. When the process 100 is started up again, the normal state of the actuator arrangement 106 is also returned. However, the actuator arrangement 106 has a delay to fully recover from the change of state caused by the operational break and hence its behavior to regulate the process 100 is different and changing along with the time till a steady state process is reached. This delay may be called transient period.

The function associated with or representing the time dependent disturbance may be available for the feed forward controller part 1040. That the function associated with the time dependent disturbance is available may mean that function is stored in a memory or the feed forward controller part 1040 may form the function on the basis of information on the actuator arrangement 106. The data associated with the future controlled variable may comprise at least one future controlled variable or at least one change of the future controlled variable. In addition to the function, the feed forward controller part 1040 may form the data associated with the future controlled variable on the basis of the measured controlled variable data. Furthermore, the feed forward controller part 1040 may use at least one formed manipulated variable to form the data about the future controlled variable. Here, the manipulated variable and the controlled variable may be expressed as at least one vector or matrix with one or more elements.

In an embodiment, the feed forward controller part 1040 may use a history of controlled variable data for the function representing time dependent disturbance. The history of the controlled variable data may refer to the present transient period and/or to at least one previous transient period. In this manner, information can be collected on relationship between the change in manipulated variable and the resulting controlled variable. The relationship, in turn, gives information for the function, such as a type of the function, value of each coefficient. Furthermore, the function coefficient may be associated with a time constant starting from the time the actuator 106 was switched on after the process resumes, and this time constant may be estimated from previous process start behavior. Then the optimizing controller part 1042 of the predictive controller 104 forms a present manipulated variable for the actuator arrangement 106 on the basis of the data associated with the future controlled variable in order to regulate the process 100.

FIG. 2 shows an example of a measuring and controlling configuration associated with caliper, surface property or the like of a paper sheet. In manufacturing or processing of a continuous sheet, the quality of the sheet is usually measured across the web by measurement arrangement 1020, 1022 performing cross-directional (CD) measurements. Typical variables measured in CD measurements are moisture content, caliper and basis weight. Measurement results are compared with set values and an error profile is formed to show the difference between the measurement results and the set values. A process in a state matching the set values is known to produce a sheet of a desired quality and, thus, the process should be kept in a state matching the set values as exactly as possible. By means of the error profile and a nominal process model, a controller 104 gives a control command to actuator arrangement 200, 204, 206, which alter the process according to the command to maintain good quality of the paper being made.

The caliper profile of the sheet 10 may be controlled in post-drying section of a paper machine. In an embodiment, the measurement arrangement 102 may provide the predictive controller 104 with data associated with caliper of the sheet 10. The predictive controller 104 may estimate at least one future caliper profile or at least one change of the future caliper profile as a time dependent function which compensates for the time dependent disturbance associated with a profiler 200 in a transient period. In this example, the profiler 200 is a caliper profiler. The predictive controller 104 may form a manipulated variable for the profiler 200 on the basis of the at least one estimated future caliper profile in order to regulate the process 100. The time dependent disturbance may relate to the process regulated by the caliper profile or the time dependent disturbance may relate to the caliper profile itself. Correspondingly, the time dependent disturbance may be understood to be caused by the process regulated by the caliper profile or the time dependent disturbance may be understood to be caused by the caliper profile itself.

In an embodiment, the measurement arrangement 102 may provide the predictive controller 104 with data about at least one surface property of the sheet 10. The predictive controller 104 may estimate at least one future sheet property or at least one change of the future sheet property as a time dependent function which compensates the time dependent actuator disturbance associated with the profiler 200 during a transient period. In this example, the profiler 200 includes also a surface profiler (surface profiler as such is not shown in Figures). The predictive controller 104 may form a manipulated variable for the profiler 200 on the basis of the at least one future surface property. In an embodiment, the sheet property includes gloss and caliper but is not limited to these.

The implementation of the time dependent function may be a temporally varying coefficient multiplied by change of the present surface property or other paper quality property like caliper. That changing coefficient has an initial value and decay as a function of time. The function may be of the first order. Obviously the time dependent constant may be approximated to follow the cooling (or heating) process variation and the initial value may be a tuning parameter. The initial value may be tuned bigger or smaller based on observed recovery trend.

Other possibly measured properties may be a moisture content, basis weight, ash content, carbonate content, brightness, smoothness, hardness or temperature of the sheet 10.

In an embodiment, the measurement arrangement 102 may comprise a scanning sensor 1020 which traverses over the sheet 10 (two-headed array illustrates the movement). The scanning sensor 1020 may gather data about the sheet 10 having both machine direction and cross direction information mixed together. However, the two pieces of information may be separated from each other by a suitable signal processing in the controller 104.

In an embodiment, the measurement arrangement 102 may comprise an array measuring unit 1022 comprising at least two measuring parts 1024 successively in a direction transverse relative to the machine direction (the arrow over the sheet 10 shows the movement of the sheet 10 in the machine direction). The measurements of the sheet 10 may be performed one sided or two sided with respect to the sheet 10.

A stack of rotating rollers represented in FIG. 2 by two rolls 204, 206 is itself an actuator and may exert pressure onto the sheet 10 which passes between the rolls 204, 206. The higher the pressure the smoother and the thinner the sheet 10 becomes. In an embodiment, the profiler 200 may comprise a plurality of actuator units 202(1), 202(2), 202(3). FIG. 2 shows only three actuator units but in reality the number of actuator units may vary from two to hundreds or thousands.

In an embodiment, the actuator units 202(1) to 202(3) may comprise air sources which may blow hot or cold air on the roll 204, for example. If cold air is blown, a circumference of the roll 204 becomes locally shorter and the diameter of the roll at the location affected by the cold air shrinks which, in turn, results in a local pressure drop on the sheet 10. If, on the other hand, hot air is blown against the roll 204, the sheet 10 is locally compressed more intensively.

In an embodiment, the actuator units 202(1) to 202(3) may comprise induction heaters each of which heats one location of the roll 204. The roll 204 may comprise at least one ferrous material. When high frequency electric current is fed in an induction heater it induces local eddy currents in the ferrous material which in turn causes the roll 204 to heat locally. The heating and cooling of the roll 204 changes the pressure on the sheet 10 in a similar manner as discussed in conjunction with the hot and cold air.

A change in pressure on the sheet 10 caused by the calendar 204, 206 has effect on properties of the sheet 10 where the properties may be caliper, gloss, opacity, at least one surface property or the like.

When the actuator arrangement 106 is driven out of a normal regulating state, which may take place during an operational break, and set back in operation, the actuator arrangement 106 may be in a different state than before the operational break. Thus, the profiler 200 may be thermally in a different temperature than before the operational break, for example. The diameter profile of the roll 204 may be different from what is desired at the beginning of the transient period but it actually is not known if it is different or how much it may differ from a desired setpoint. However, typically the roll 204 is too hot or too cool after an operational break.

Similarly, the actuator arrangement 106 comprising the stack rollers (204, 206) may be mechanically in a different position than before the break irrespective of how well the actuator arrangement 106 is attempted to be returned to its original state. The reason for that is that the nip of the rollers is typically opened during the sheet break and it cannot be returned exactly.

Hence, the time dependent disturbance is associated with the actuator arrangement 106 and that is why the disturbance should be taken into account in its own manner to compensate for its time varying effect in the controller 104.

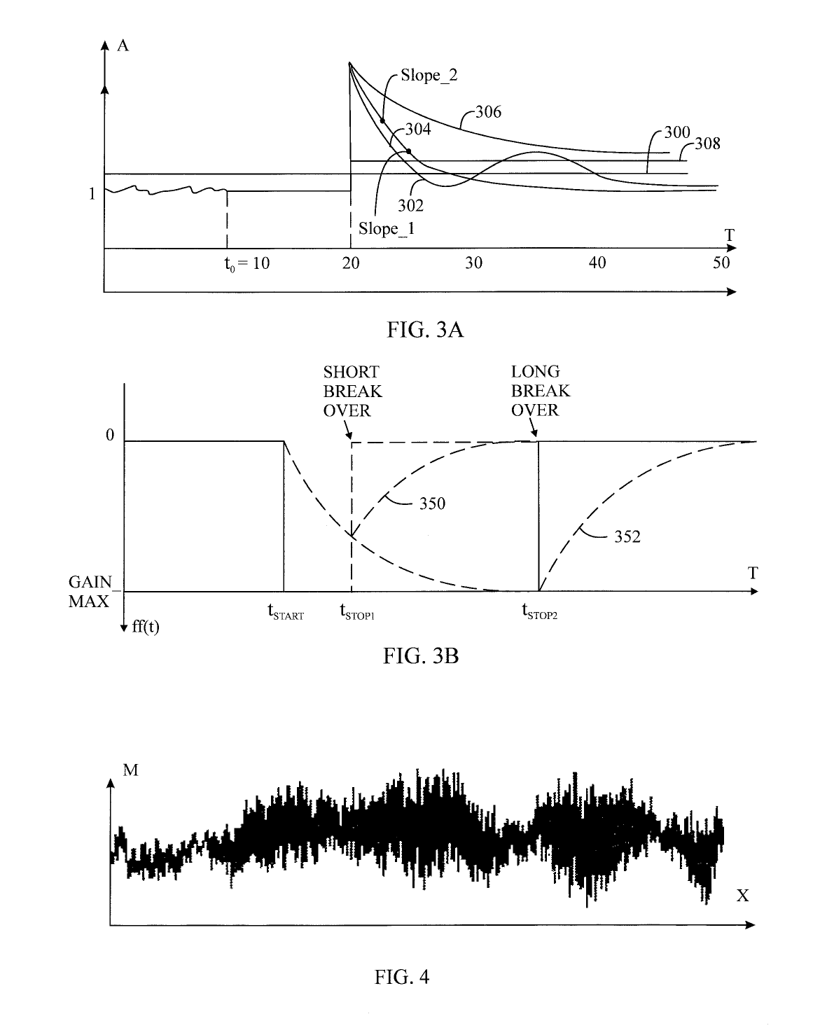

FIG. 3A presents an example of a sheet variation quality trajectory behavior with and without the function compensating for the time dependent disturbance. The smaller the value of the variation is the better quality. The vertical axis means amplitude A of the quality variation in an arbitrary scale and the horizontal axis means time T. The operational break is assumed to happen at t₀=10 min and it lasts for 10 min after which the process is restarted. The decaying curve 306 represents a behavior of the time dependent disturbance. The disturbance may be an increase or a decrease of temperature of the actuator arrangement such as stack rollers after the operational break.

After a break, the sheet quality variation typically jumps to a high value represented by line 306. Alternatively, it may go abruptly down. In general, the quality may have a large deviation from what is desired after a break. The variation can by decomposed to two parts: a static error higher than pre-break variation represented by line 308, which needs a control action to bring the quality back to under the threshold line 300; a transient part represented by the area between line 306 and line 308, which will disappear after a long period without any control action. The size of the variation may be related to the length of the operational break. The temperature may be cooling down or heating up but the behavior is actuator arrangement-specific such that each actuator arrangement in each paper machine may have its own kind of behavior. The dynamic temporal behavior may depend on heat capacity of the calendar, for example. A general model may be difficult or impossible to achieve. The disturbance disappears when the temperature is stabilized to the steady-state level after the transient period. The area between the line 308 and the setpoint is controllable variation which is likely related to the operation change and/or the length of the operational break.

The process has drifted far away from the set point value which in this FIG. 3A is at value 1 and even from quality threshold 300. The actuator arrangement is in the transition period for more than ten minutes. The trajectory 302 of the process without disturbance compensation decays quickly towards the set point value but because of oscillation it takes more than 20 minutes before the trajectory 302 fully remains in a range of acceptable quality. The trajectory 304 with the control having disturbance compensation decays in this example slightly more slowly although in general the decay may not differ. However, the trajectory 304 remains in the range of acceptable quality much faster than trajectory 302 i.e. in less than 10 minutes.

In the case, the actuator arrangement is a super calendar there are a plurality of nips to be controlled using the model of temporal disturbance. The more nips there are, the more advantageous it is to use the model of the temporal disturbance.

Examine now the mathematics in a controller 104 which may be based on an MPC (Model Predictive Control) or GPC (General Predictive Control) multivariable control or the like. The controller may be considered as a control arrangement based on automatic data processing of the paper machine, or as a part thereof. The controller may receive digital signals or convert the received analog signals to digital signals. The controller may comprise a microprocessor and memory and process the signal according to a suitable computer program.

As to mathematics related to the control, the steady state control may be expressed as an optimization algorithm (state of art) such that the predicted profile error is minimized subject to a set of actuator constraint related cost functions. That is, the control action Au is such that the following cost function J is minimized.

J=Σᵢ₌ₕ_{ₘᵢₙ}^{h}^{ₘₐₓ}∥\hat{P}ₜ₊ᵢ−P_{tgt}∥²+Σᵢ₌₁^{M}pᵢ(u,Δu), (1)

where
u is the current actuator profile;
Δu is the control action profile;
i is an index i=1, 2, . . . M;
pᵢ(u,Δu) refers to M actuator profile penalty functions. Typical actuator penalty
functions are an actuator deviation penalty, an actuator bending penalty and
an actuator filtering penalty. It is a specific function (usually first or second
order polynomial function) of u and Δu;
P_{tgt} is the target sheet quality profile.
\hat{P}ₜ₊ᵢ is the predicted future sheet quality profile using a model and history control actions at time t+i where t is the current time; and
hₘᵢₙ and hₘₐₓ are minimum and maximum prediction horizon respectively.

When using feed-forward, the optimization may minimize the following modified cost function:

J=Σᵢ₌ₕ_{ₘᵢₙ}^{h}^{ₘₐₓ}∥Fₜ₊ᵢ+\hat{P}ₜ₊ᵢ−P_{tgt}∥²+Σᵢ₌₁^{M}pᵢ(u,Δu), (2)

where Fₜ₊ᵢ is the future disturbance effect to be compensated at time t+i.

A steady state control of a predictive controller may be presented for simplicity as:

vₘ=vₘ₋₁+Σ_{j=m-d}^{m-1}Σᵢuᵢⱼzᵢⱼ, (3)

where vₘ is a controlled variable (process output), uᵢⱼ is a value of a manipulated variable (process input), zᵢⱼ is a coefficient in the steady state model, j is index for time, m is current moment of time, i is index for the variable and d refers to past moments.

Alternatively, the manipulated variable uᵢⱼ may be replaced by a change of the manipulated variable Δuᵢⱼ such that

vₘ=vₘ₋₁+Σ_{j=m-d}^{m-1}ΣᵢΔuᵢⱼzᵢⱼ. (4)

A change in a future manipulated variable Δu_{f} may be expressed as

Δu_{f}=f(t, Δu), (5)

where f means a predetermined time dependent function which compensates for the time dependent disturbance, t means time and Δu means at least one present or previous change of the manipulated variable with respect to the future change. The at least one present or previous change of the manipulated variable may be based on already performed actions or actions to be performed now. The time t may be measured from the beginning of transient time i.e. from the moment when the actuator arrangement is initiated for the first time or again after the operational break. The function f may be a linear function, a non-linear elementary function or a non-elementary function. An example of non-linear elementary function is a polynomial function the degree of which is different from 1 and 0. A linear function may be a polynomial function the degree of which is 1. The function f may be ff(t)*Δu, where ff(t) is a function of time t and sign*means a multiplication operation. The function ff(t) may change dynamically with time and it may be an exponential function b*e^{kt} which may rise or decay depending on the value of constant k and where e means Euler's number (about 2.71828182). The initial value b is a tuning parameter. The exponential function e^{kt} may be approximated. The approximation may be linear such as e^{kt}≈(1+kt).

The constant k may be decided by the operator. The constant k may be adaptable such that it changes as more and more information of the behavior the process 100 such as behavior of manipulated variable and controlled variable during the transient periods is collected by the controller 104.

In an embodiment, the manipulated variable may be caliper of the sheet 10 and the future change dPF of the caliper may be expressed as

dPF=f(t, dPC), (6)

where dPC is a current or previous change of the caliper. The future change of the caliper dPF may also be written as

dPF=ff(t)*dPC, (7)

where the function ff(t) may be an approximation of (a*Slope_{—}2)/(Slope_{—}1), where a is a constant, Slope_{—}2 is a next value of a slope of the caliper variation trajectory and Slope_{—}1 is a previous value of the slope of the caliper variation trajectory of the process 100 (see FIG. 3A). The slope may be defined as a value of a derivative of the caliper variation trajectory. The constant may be 2, for example.

FIG. 3B shows an example of an effect of a length of a break on the function ff(t). The vertical axis represents a value for the function ff(t) and the horizontal axis is time, both axes being in an arbitrary scale. It is assumed that the break starts at t_{START}. A short break may end at t_{STOP1}. A long break may end at t_{STOP2}. The temporal duration between t_{START} and t_{STOP1} is shorter than that of t_{START} and t_{STOP2}. The short break may last for a few minutes for example whereas the long break may last for more than 10 minutes for example. The function ff(t) may be different for a short break than for a long break. Curve 350 represents the function ff(t) for a short break and curve 352 represents the function ff(t) for a long break. Their values may be different. Actually the function ff(t) may be constantly zero for a steady state and the function ff(t) may be GAIN_MAX for a long break, where GAIN_MAX means a maximum value used in the control. For a short break, the function fft(t) may be between zero and GAIN_MAX. The value of the function ff(t) may thus be adaptive and depend on the length of the break.

A future change in a controlled variable Δv may now be written as

Δv=vₘ₊₁−vₘ=Σ_{j=m-d}^{m-1}ΣᵢΔuᵢⱼzᵢⱼ+f(t,Δu). (8)

Hence, a future controlled variable vₘ₊₁ may be written as

vₘ₊₁=vₘ+Σ_{j=m-d}^{m-1}ΣᵢΔuᵢⱼzᵢⱼ+f(t,Δu) (9)

The result is the same irrespective whether vₘ₊₁ and vₘ are symbols for the actual controlled variable or for errors between a target and the actual controlled variable (vₑ, v_{ef})

The MPC checks how near or how far the process was, is or will be from a setpoint using a cost function. The cost function for a standard MPC may be given as a 2-norm, but other norms can be used equally well. The cost function q may be expressed as:

$$q = {\sum }_{j = Min}^{Max} {{w}_{kj} ( {r}_{kj} - {v}_{kj} )}^{2} \qquad ( 10 )$$

where
rₖⱼ is setpoint trajectory for controlled variable k at time moment j
j is index for present and future moments of time from a predetermined minimum (Min) to a predetermine maximum (Max)
vₖⱼ is value of controlled variable k at time moment j,
wₖⱼ is weight factor for error in controlled variable k at time moment j.

The error term (rₖⱼ−vₖⱼ)² is comparable to the absolute value of the difference between the setpoint variable r and the controlled variable v. The setpoint trajectory rₖⱼ may be provided by a human operator or by a table of product specifications. The weight factors wₖⱼ may define a time window for each controlled variable, and a relative importance of that variable compared to the others at each moment in the window.

In an embodiment, all points of moment j may be in future time points. The controlled variable values vₖⱼ at times in the future may be based on a steady state model, and additionally on the function f estimating the time dependent disturbance in the process control during a transient period. The controlled variable may also be based on knowledge of past control actions.

In general, there may also be a cost associated with each manipulated variable, and a cost associated with control action magnitudes, so that the cost function q may more generally be presented as:

$$q = {\sum }_{j = 1}^{n} {{w}_{kj} ( {r}_{kj} - {v}_{kj} )}^{2} + {\sum }_{j = 0}^{m} {{b}_{i} ( {p}_{i} - {u}_{ij} )}^{2} + {\sum }_{j = 0}^{m} {c}_{ij} Δ {u}_{ij}^{2} \qquad ( 11 )$$

where
pᵢ is minimum cost state for manipulated variable i found by the optimization of q
Δuᵢⱼ is change in manipulated variable i at time moment j and
bᵢ is a cost multiplier for manipulated variable i and cₖⱼ is a weight factor for control action i at time tⱼ.
   The change in manipulated variable Δuᵢ is expressed as Δuᵢ=uᵢ−uᵢ₋₁. There may also be constraints on the manipulated variables, typically of a simple limit type, and there may be an amplitude constraint on the control actions expressed as limitations to the manipulated variable:

u_{i,min}≦uᵢⱼ≦u_{i,max}

∥Δuᵢⱼ∥≦Δu_{i,max} (12)

where u_{i,min} and u_{i,max} are the upper and lower limits for manipulated variable uᵢ, and Δu_{i,max} is maximum allowed single change of the manipulated variable. A standard MPC comprises finding a schedule of m+1 control states uᵢⱼ from t₀ to tₘ which minimizes the cost function q

$${min}_{u} \{ q \vert {u}_{i , min} \leq {u}_{ij} \leq {u}_{i , max} , ‖ Δ {u}_{ij} ‖ \leq Δ {u}_{i , max} \} \qquad ( 13 )$$

in which none of the manipulated variables violate their constraints ∥Δuᵢⱼ∥≦Δu_{i,max} and u_{i,min}≦uᵢⱼ≦u_{i,max}.

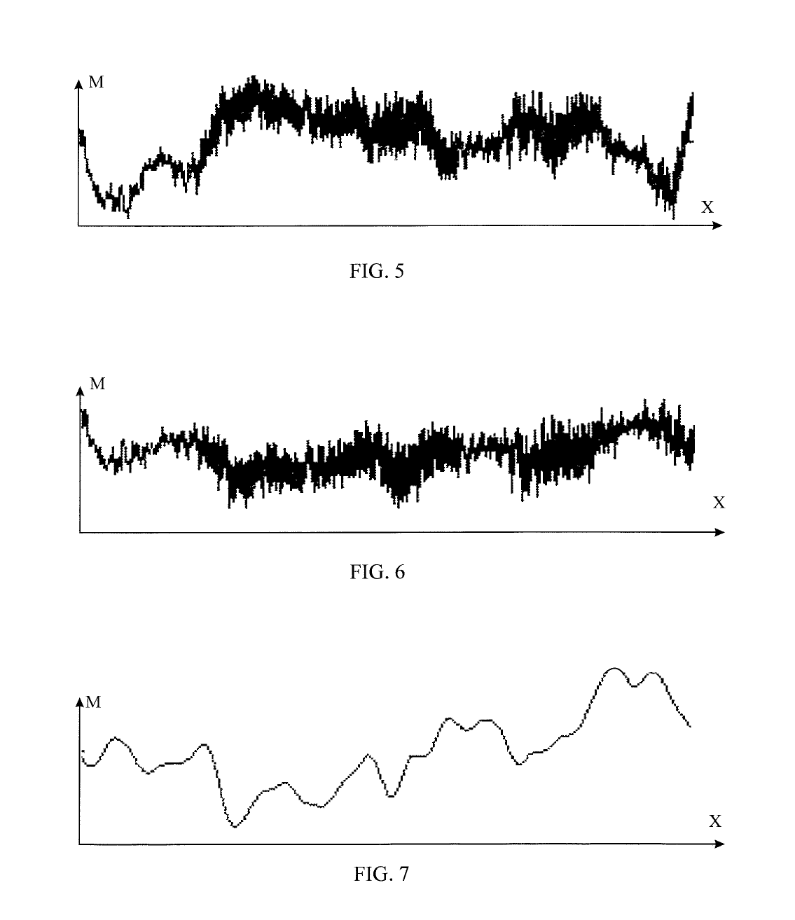

FIG. 4 presents an example of a measured caliper profile (manipulated variable u) at a present moment. FIG. 5 presents an example of a present error between the measured caliper and a target caliper (yₑ). FIG. 6 presents an example of predicted error at a future moment (v_{ef}). FIG. 7 presents an example of a feed forward error profile on the basis of equation (7).

In an embodiment shown in FIG. 7, the change in error is also filtered such that it is smoother. The filtering may be low-pass filtering, median filtering or averaging filtering, for example. Filtering high frequencies out provides a more aggressive control towards long wavelengths of the caliper profile, for example.

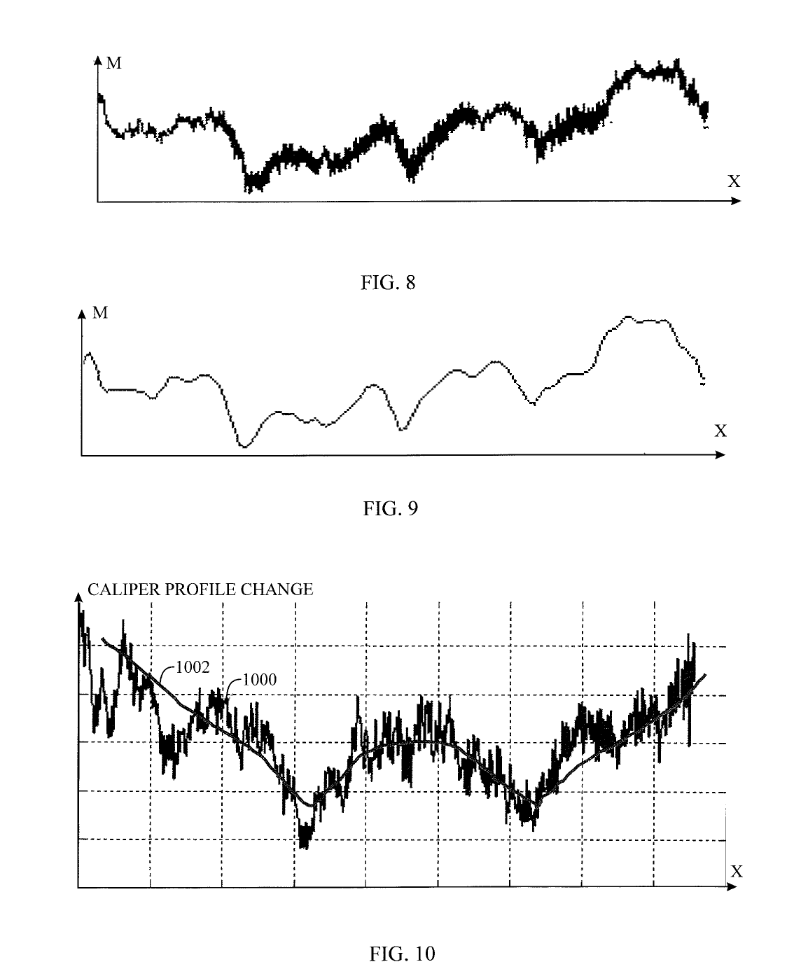

FIG. 8 presents an example of a predicted future caliper change formed using the principle of equations (7) and (8) related to the future controlled variable Δv. In FIGS. 4 to 8, the vertical axis represents a magnitude M and the horizontal axis represents the location x in the cross direction.

FIG. 9 presents an example of a manipulated variable used as control action for a caliper profiler. The control action follows the estimated future change of the controlled variable.

In an embodiment, calendar loads to the caliper profile may also be modeled using the feed-forward of the cross-direction control. A model which may is a spatial model may be formed by tests with different loads and measuring the caliper profiles after each test load. Hence in general, a predetermined model may be based on temporally and/or spatially dependent disturbance associated with the actuator arrangement.

The operator may change, at his/her will, the calendar load and that can be considered as an external feed-forward command because the command goes through optimization before it is actually causing an effect in the process, and the MPC controller can take into account the command before it's effects are seen in the feedback.

A shape of calendar similar to the calendar of rolls 204 and 206 in FIG. 2 may be changed by crowning and/or adding gas or oil pressure in at least one of the rolls 204, 206, for example.

A change in caliper profile can be measured for each possible command beforehand and the results may be used to form a model. Hence, the next (future) caliper profile vⱼ₊₁^{p} may be written, for example, as: v_{i,j+1}^{p}=v_{i,j}^{p}+(u_{i,j}^{p}−u_{i,j-1}^{p})·zᵢ, where u_{i,j}^{p}−u_{i,j-1}^{p} means a present change command of a manipulated variable (=nip load change) and zᵢ is a coefficient in the model (Here, vector representation have not been used for simplicity). The future caliper profile can be used for optimization in the controller 104.

FIG. 10 presents an example of a test where pressure in the middle of a calendar is added by 1.5%. The vertical axis means profile change in an arbitrary scale and the horizontal axis means a place X along the calendar axis. The pressure addition changes the profile 1000 such the profile 1000 becomes thicker in both ends of the calendar. The reason may be a decrease of pressure. From the ends towards the center of the calendar the profile 1000 gets thinner probably due to the increased pressure. But in the mid area of the calendar the profile 1000 becomes thicker again. This is an unpredictable change because an increased pressure should make the profile thinner. Curve 1002 represents a model made of this test. The model may be made by filtering the measured profile 1000. The filtering may be a low pass, average or mean filtering, for example.

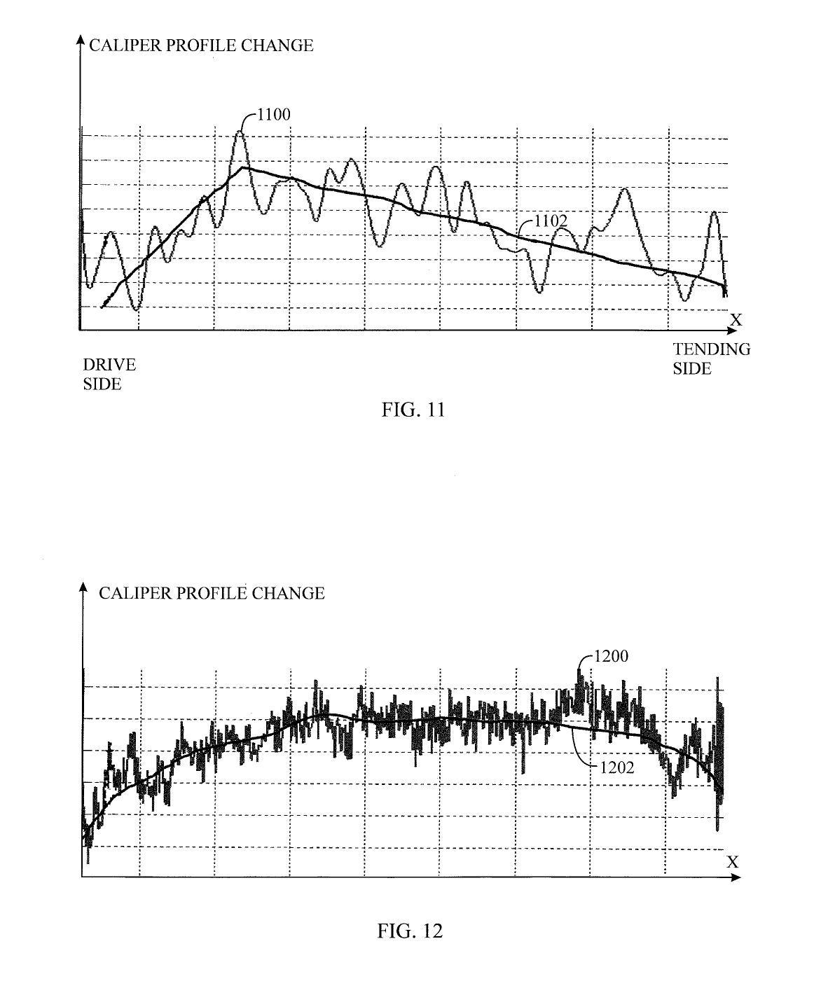

FIG. 11 presents another example of test where pressure at tending side of the calendar is decreased by 1 kN/m. The caliper changes in this test such that the caliper 1100 becomes thinner at both ends of the calendar but the thickest caliper is more towards a drive side. A model curve 1102 may be formed by filtering the caliper curve 1100.

FIG. 12 presents still another example of test where pressure is increased by 2 kN/m both at a drive side and at a tending side of the calendar.

The caliper 1200 decreases at both ends and increases a little in the middle. A model curve 1202 may be formed by filtering the caliper curve 1200.

The model may compensate for general and/or individual differences of calendars. The differences may be deforms or other non-ideal shapes.

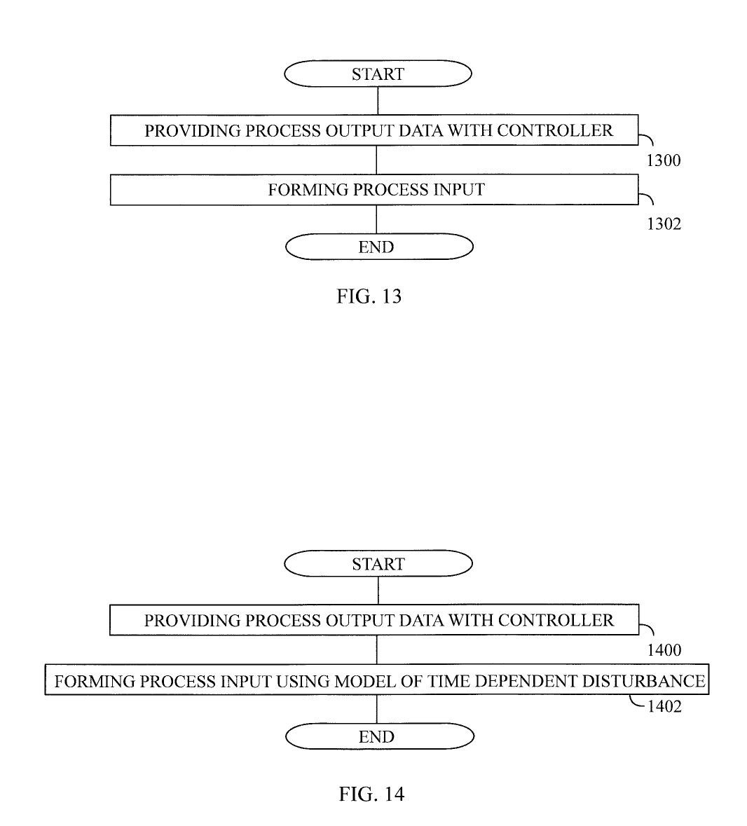

FIG. 13 illustrates an example of a flow chart of the method. In step 1300, a measurement arrangement provides a controller with controlled variable data about at least one property of the sheet. In step 1302, the controller forms a manipulated variable for an actuator arrangement on the basis of a predetermined model based on time dependent disturbance in response to the disturbance.

FIG. 14 illustrates an example of a flow chart of the method based on the model of the time dependent disturbance. In step 1400, a measurement arrangement provides a controller with controlled variable data about at least one property of the sheet. In step 1402, the controller forms a manipulated variable for an actuator arrangement regulating at least one property of the sheet on the basis of a predetermined model based on time dependent disturbance during a transient period of the manufacturing process in response to the disturbance.

In an embodiment, the device implementing aspects of the invention may be realized as software, or computer program or programs in a computer or computers of a processing system.

The computer programs may be in source code form, object code form, or in some intermediate form, and it may be stored in some sort of carrier, which may be any entity or device capable of carrying the program. Such carriers include a record medium, computer memory, read-only memory, and software distribution package, for example. Depending on the processing power needed, the computer program may be executed in a single electronic digital controller or it may be distributed amongst a number of controllers.

It will be obvious to a person skilled in the art that, as technology advances, the inventive concept can be implemented in various ways. The invention and its embodiments are not limited to the examples described above but may vary within the scope of the claims.

1. An apparatus, wherein the apparatus in a manufacturing process of a sheet comprising:
a measurement arrangement, a controller and an actuator arrangement regulating at least one property of the sheet;
the measurement arrangement being configured to provide the controller with controlled variable data about at least one property of the sheet;
the controller having available a predetermined model based on temporally or spatially dependent disturbance; and
the controller being configured to form a manipulated variable for the actuator arrangement on the basis of the model in response to the disturbance.

2. An apparatus, wherein the apparatus in a manufacturing process of a sheet comprising:
a measurement arrangement, a controller and an actuator arrangement regulating at least one property of the sheet;
the measurement arrangement being configured to provide the controller with controlled variable data about at least one property of the sheet;
the controller having available a predetermined model based on time dependent disturbance during a transient period of the manufacturing process; and
the controller being configured to form a manipulated variable for the actuator arrangement on the basis of the model.

3. The apparatus of claim 1, wherein the controller being configured to form data associated with at least one future controlled variable as a time dependent function of a change in the measured manipulated variable, the time dependent function estimating the time dependent disturbance associated with the actuator arrangement in a transient period, and
the controller being configured to form a manipulated variable for the actuator arrangement on the basis of the formed data about the at least one future controlled variable.

4. The apparatus of claim 2, wherein the controller being configured to form data of at least one change of the future controlled variable as the time dependent function of the change in the measured manipulated variable,
the controller being configured to form the manipulated variable on the basis of the change of the at least one future controlled variable.

5. The apparatus of claim 2, wherein the controller comprises a feed forward controller part and an optimizing controller part; the feed forward controller part being configured to form the data associated with at least one future controlled variable as the time dependent function of the change in the measured manipulated variable; the optimizing controller being configured to form, using optimization, the manipulated variable on the basis of the formed data associated with the at least one future controlled variable.

6. The apparatus of claim 1, wherein the model being further being based on at least one of the following: the measured controlled variable data and the at least one manipulated variable formed by the controller during the transient phase.

7. The apparatus of claim 1, wherein apparatus comprising and an at least one caliper profiler of the sheet;
the measurement arrangement being configured to provide the controller with data about caliper of the sheet;
the controller having available the predetermined model based on the time dependent disturbance associated with the caliper profiler during a transient period; and
the controller being configured to form the manipulated variable for the caliper profiler on the basis of the model.

8. The apparatus of claim 6, wherein the controller being configured to form data associated with at least one future caliper as a time dependent function of a change in the measured caliper, the time dependent function estimating the time dependent disturbance associated with the caliper profiler in a transient period, and form a control action for the caliper profiler on the basis of the data associated with the at least one future caliper.

9. The apparatus of claim 1, wherein the controller being configured to filter out high frequencies in conjunction of forming the manipulated variable.

10. An apparatus, wherein the apparatus for controlling a process of sheet manufacturing during a transient phase of the process comprises
at least one processor; and
at least one memory including computer program code, the at least one memory with the at least one processor and the computer program code being configured to cause the processing unit at least to form a manipulated variable for an actuator arrangement regulating at least one property of the sheet on the basis of a predetermined model based on temporally or spatially dependent disturbance associated with the actuator arrangement in response to the disturbance.

11. The apparatus of claim 10, wherein the at least one memory with the at least one processor and the computer program code being configured to cause the processing unit to form a manipulated variable for the actuator arrangement on the basis of the predetermined model based on the time dependent disturbance during a transient period of the manufacturing process

12. The apparatus of claim 10, wherein the at least one memory with the at least one processor and the computer program code being configured to cause the processing unit to estimate at least one future controlled variable or at least one future change of the controlled variable on the basis of the model of time dependent disturbance associated with the actuator arrangement.

13. The apparatus of claim 10, wherein the at least one memory with the at least one processor and the computer program code being configured to cause the processing unit to filter out high frequencies in conjunction of forming the manipulated variable.

14. A method in a manufacturing process of a sheet, comprising:
providing, by a measurement arrangement, a controller with controlled variable data about at least one property of the sheet; and
forming, by the controller, a manipulated variable for an actuator arrangement regulating at least one property of the sheet on the basis of a predetermined model based on temporally or spatially dependent disturbance in response to the disturbance.

15. A method in a manufacturing process of a sheet, comprising:
providing, by a measurement arrangement, a controller with controlled variable data about at least one property of the sheet; and
forming, by the controller, a manipulated variable for an actuator arrangement regulating at least one property of the sheet on the basis of a predetermined model based on time dependent disturbance during a transient period of the manufacturing process in response to the disturbance.

16. The method of claim 14, the method further comprising forming, by the controller, data associated with at least one future controlled variable as a time dependent function of a change in the measured manipulated variable, the time dependent function estimating the time dependent disturbance associated with the actuator arrangement in a transient period; and
forming, by the controller, a manipulated variable for the actuator arrangement on the basis of the formed data about the at least one future controlled variable.

17. The method of claim 14, the method further comprising filtering out high frequencies in conjunction of forming the manipulated variable.

18. A computer program distribution medium readable by a computer and encoding a computer program of instructions for executing a computer process carrying out the method according to any of claims 14 to 17.
